(19) United States
(12) Patent Application Publication
(10) Pub. No.: US 2007/0143716 A1
(43) Pub. Date: Jun. 21, 2007

(54) Circuit layout compaction using reshaping

(76) Inventors: Robert Lee Maziasz, Austin, TX (US); Alexander Mikhailovich Marchenko, Moscow (RU); Mikhail Anatolievich Sotnikov, Moscow (RU); Igor Georgievich Topuzov, Moscow (RU)

Correspondence Address: FREESCALE SEMICONDUCTOR, INC.;LAW DEPARTMENT, 7700 WEST PARMER LANE MD:TX32/PL02, AUSTIN, TX, 78729, US

(21) Appl. No.: 10/596,944

(22) PCT Filed: Dec. 29, 2003
(86) PCT No.: PCT/RU03/00595

§ 371 Date: Jun. 29, 2006

(51) Int. Cl. G06F 17/50

(52) U.S. Cl. 716/2

(57) ABSTRACT

A critical path minimization technique uses a novel reshaping layout reorganization mechanism. Circuit objects and/or object fragments which belong to a critical path in a reference direction are reshaped using resources of an orthogonal direction. A fragment may decrease its size in the layout in the reference direction and increase its size in the orthogonal direction. Types of reshaping include via, diode or tie reshaping, transistor chain reshaping by transistor finger resizing, and transistor chain reshaping by transistor finger removing. The removal technique can include removal of one (or 2N+1) transistor finger(s) from an edge (e.g., beginning or end) of a transistor chain, removal of two (or 2N) adjacent transistor fingers from any position of a transistor chain, removal of one (or 2N+1) transistor finger(s) from inside a transistor chain with diffusion gap insertion, and removal of a group or series of transistor fingers. Such reshaping can allow a more effective compaction of a circuit layout

### BACKGROUND

1. Field

The present invention relates to automated circuit design techniques and apparatus therefor, and more particularly to techniques and apparatus for compaction of a circuit layout.

2. Description of the Related Art

Integrated circuits (ICs) such as very large scale integration (VLSI) circuits are traditionally designed and laid out using a phased approach. Compaction is an important design automation stage of the phased approach to layout synthesis. The compaction operation converts symbolic layouts generated by other layout synthesis tools into mask data or physical layouts and attempts to optimize the area of the layout without violating design rules. It is desirable to make each chip as small as possible while maintaining design rule correctness.

Conventional graph-based compaction techniques compact circuit elements in two dimensions of a circuit layout. A circuit layout representation is converted to a constraint graph representation in a reference direction. An orthogonal constraint graph is also constructed. A critical path subgraph is constructed based upon the reference and orthogonal constraint graphs. The final layout size is equal to the appropriate critical path length. The well known compaction approaches use different critical path reduction techniques. The more powerful critical path reduction is used the smaller layout will be generated providing many advantages to the product incorporating the compacted circuit.

Layout compaction algorithms typically range between “one-dimensional” and “two-dimensional” compaction. Simply put, in one-dimensional compaction, one dimension (e.g., that of the reference direction) of the layout geometry is changed at a time, such as either X compaction or Y compaction. The goal of fully two-dimensional compaction, on the other hand, is to modify both X and Y coordinates simultaneously in order to minimize area.

Conventional graph based layout compaction algorithms often utilize alternately applied one-dimensional compaction. The goal of one-dimensional compaction is to minimize the length of one dimension or direction, whereas the other direction, referred to as the shear or orthogonal direction, is often not intentionally affected, and can remain substantially constant. It is noted that dimension and direction are often used interchangeably herein. After compaction occurs in the reference direction, the orthogonal direction can then become a new reference direction, and the old reference direction can then become a new orthogonal direction for a next round of one-dimensional compaction.

Many one-dimensional compaction algorithm versions can be solved efficiently without consuming significant computational resources. A few proposed versions of one-dimensional compaction and most two-dimensional compaction proposals are more computationally intensive, and even “NP-hard”, which means that they are computationally prohibitive and not practicable. To circumvent the intrinsic complexity of this problem, some heuristic methods have been proposed to relate both dimensions of the compaction. Such heuristic proposals are often referred to as “1.5-dimensional” compaction since, although they interrelate the two dimensions, they do not optimally solve the two-dimensional compaction problem entirely at the same time. Some 1.5-dimensional compaction methods have been proposed in which the layout is essentially compacted in a preferred direction, while also changing the shear or orthogonal direction, for example through shearing or jog insertion. In the process of achieving the primary goal of decreasing the extent of the layout in the preferred direction, these compaction techniques also make coordinate changes in the shear direction. Each local change is called a reorganization.

Further optimization of the effectiveness of circuit compaction is greatly advantageous. There is a continuing need for new critical path reduction techniques such as those newly disclosed herein.

### BRIEF DESCRIPTION OF THE DRAWINGS

The present invention may be better understood, and its numerous objects, features, and advantages made apparent to those skilled in the art, by referencing the accompanying drawings. The use of the same reference symbols in different drawings indicates similar or identical items.

FIG. 1 is an operational flow diagram illustrating an exemplary circuit layout technique according to an embodiment of the invention.

FIG. 2 is an operational flow diagram illustrating an exemplary reshaping technique usable in the operational flow of FIG. 1.

FIG. 3 is an operational flow diagram illustrating an exemplary pad rotational technique usable in the operational flow of FIG. 2.

FIG. 4 is a block diagram of a circuit layout prior to the pad rotation of FIG. 3.

FIG. 5 is a block diagram of a circuit layout after the pad rotation of FIG. 3.

FIG. 6 is an operational flow diagram illustrating an exemplary transistor finger reshaping technique usable in the operational flow of FIG. 2.

FIG. 7 is a block diagram of a circuit layout prior to the transistor finger reshaping of FIG. 6.

FIG. 8 is a block diagram of a circuit layout after to the transistor finger reshaping of FIG. 6

FIGS. 9 and 10 are operational flow diagrams illustrating an exemplary transistor finger removal technique usable in the operational flow of FIG. 2.

FIG. 11 is a circuit layout diagram illustrating an exemplary transistor chain with a folded transistor.

FIG. 12 is a circuit layout diagram illustrating an exemplary transistor chain with the folded transistor of FIG. 11 having a transistor finger removed.

FIG. 13 is a circuit layout diagram illustrating an exemplary transistor chain with the folded transistor of FIG. 12 having a tail interconnect removed.

FIG. 14 is a circuit layout diagram illustrating an exemplary transistor chain with the folded transistor of FIG. 13 having another transistor finger of increased width.

### DETAILED DESCRIPTION OF THE PREFERRED EMBODIMENT(S)

The following discussion is intended to provide a detailed description of at least one example of the invention and should not be taken to be limiting of the invention itself. Rather, any number of variations may fall within the scope of the invention which is properly defined in the claims following this description.

A critical path minimization technique is disclosed which uses a novel layout reorganization mechanism of reshaping. In one embodiment, circuit objects and/or object fragments which belong to a critical path in a reference direction are reshaped using resources of an orthogonal direction. A fragment may decrease its size in the layout in the reference direction and increase its size in the orthogonal direction. Types of reshaping include via, diode or tie reshaping, transistor chain reshaping by transistor finger resizing, and transistor chain reshaping by transistor finger removing. The removal technique can include removal of one (or 2N+1) transistor finger(s) from an edge (e.g., beginning or end) of a transistor chain, removal of two (or 2N) adjacent transistor fingers from any position of a transistor chain, removal of one (or 2N+1) transistor finger(s) from inside a transistor chain with diffusion gap insertion, and removal of a group or series of transistor fingers. Such reshaping can allow a more effective compaction of a circuit layout.

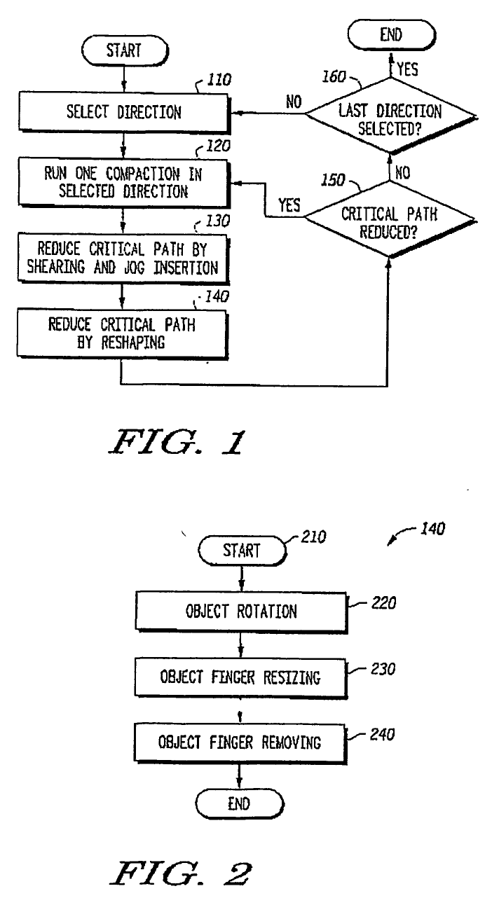

FIG. 1 shows a simplified and exemplary flow of a circuit layout technique. As illustrated, a reference direction is selected during direction selection operation 110. Compaction is then run in the reference direction during compaction operation 120. The compaction algorithm may use techniques such as shearing and jog insertion during operation 130. During operation 140, the critical path is reduced by reshaping various elements of the circuit. Typically, this reshaping is performed by reorienting or reforming (e.g., folding or unfolding) fragments of an object in the critical path. Reshaping is discussed in greater detail below. Once the critical path in the reference direction has been reduced during reshaping operation 140, the compaction system (e.g., a computer system configured by software for circuit design including compaction) determines if the critical path was reduced. If the critical path was reduced, operations 120-140 are repeated. If the critical path was not reduced, the compaction system determines if the last direction has been selected. If there is another direction which the compaction system is configured to compact, a next reference direction is selected during selection operation 110. In typical embodiments, the next reference direction will be the orthogonal direction to the initially selected reference direction. Other embodiments may select directions differently and/or may select more than two alternating reference directions.

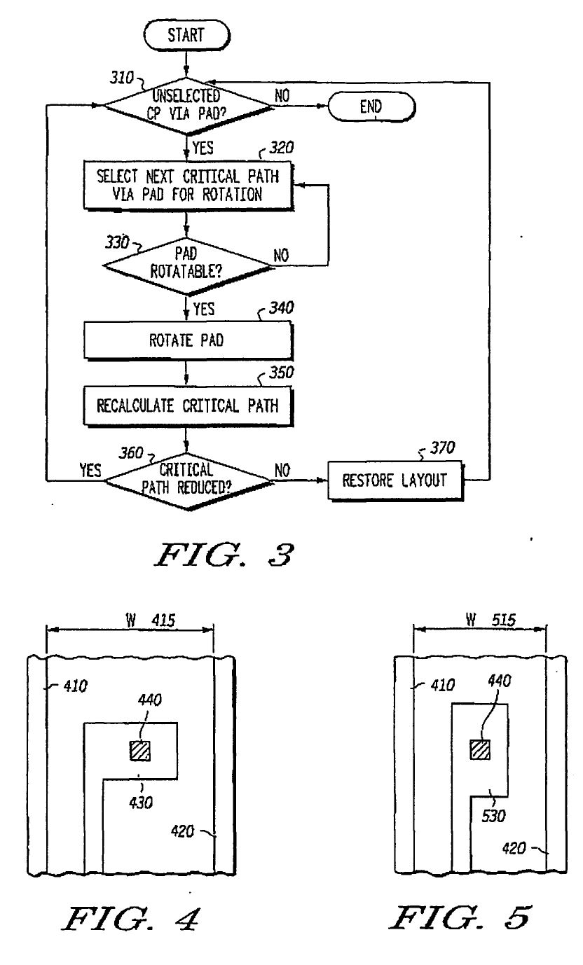

FIG. 2 shows an exemplary flow of the reshaping technique discussed above with reference to operation 140. In the embodiment illustrated, various object reshaping techniques are implemented. For example, during rotation operation 220, an object which is represented by a node of the constraint graph and which is nonsymmetrical about a central point and/or has different sizes when viewed from different directions may be rotated within the plane of the circuit to change its effect on the critical path. In this way, a smaller profile of the object may be presented in the critical path to decrease the length of the critical path. A common example of such an object is an interconnect pad. Such pads are often rectangular in shape. Consequently, such pads can often be rotated so that their physical width is along the critical path instead of their physical length. Some exemplary objects which may be rotated in this fashion are via pads and tie pads which are often rectangular, diodes including diode pads, via and substrate portions thereof, and antenna diodes which are often long and narrow, etc. Rotation operation 220 is discussed in greater detail below with reference at least to FIGS. 3-5.

After rotation operation 220, the critical path is scanned for folded objects and/or objects with resizable extensions (e.g., a transistor finger of a transistor) which may be available for resizing during resize operation 230 to decrease a critical path. For example, a folded transistor may include two or more transistor fingers which may be resized so that a first finger having a longer feature length in the critical path may be shortened with a corresponding increase in feature length of another finger or fingers not in the critical path. As is well known in the art, transistor folding is a process of splitting a logical transistor in a circuit net list into multiple physical transistors called legs or fingers of the logical transistor. The folded net list is electrically equivalent but structurally distinct. Capacitors may also be resizable during resizing operation 230 (e.g., capacitively-coupled transistors). Resize operation 230 is discussed in greater detail below with reference at least to FIGS. 6-8.

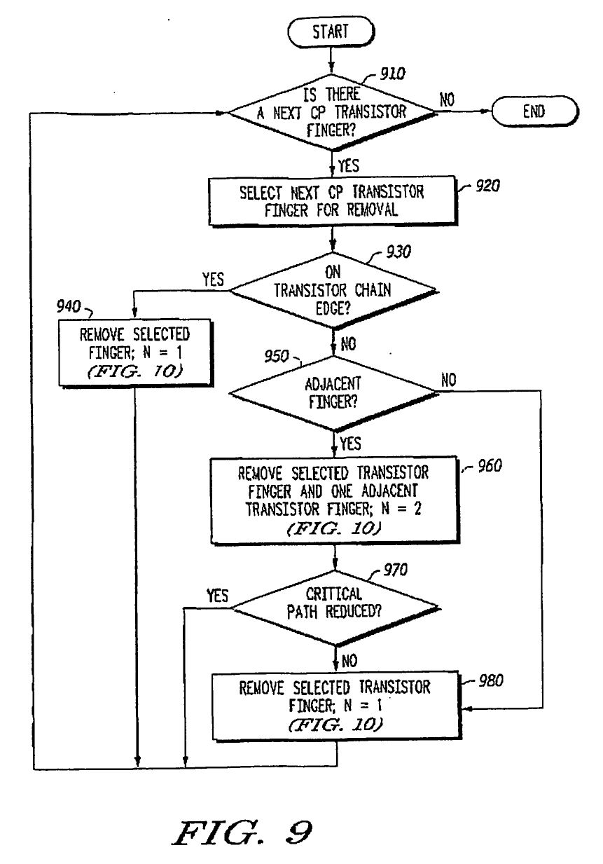

After resize operation 230, the critical path is scanned for folded objects and/or objects with extensions (e.g., a transistor finger of a transistor) which may be available for removal during removal operation 240 to decrease a critical path. For example, a folded transistor may include two or more folded portions or transistor fingers, some of which may be removable to reduce the critical compaction path in the reference direction. Removal operation 240 is discussed in greater detail below with reference at least to FIGS. 9-14.

FIG. 3 is an operational flow diagram illustrating an exemplary interconnect pad rotational technique usable in the operational flow of FIG. 2. Using this operational flow, for example, pads of a via which are not square may be rotated to reduce the critical path. In the illustrated embodiment, if there are any unselected via pads in the critical path (CP) which have not been selected during decision 310, a next critical path via pad is selected for rotation during pad select operation 320. If the selected pad is determined to not be rotatable during decision 330, another next critical path via pad is selected during pad select operation 320. For example, if the pad is square, rotating it will not affect its size in the critical path direction if the compaction system rotates in 90° increments. If the selected pad is rotatable, the pad is rotated during rotate operation 340. After the pad is rotated, the critical path is recalculated during recalculate operation 350. If the critical path is determined to have been reduced during decision 360, and if there is at least one other as yet unselected via pad, further critical path compaction occurs in at least another iteration of operations 320 through 350. If the critical path was not reduced during the most recent iteration of operations 320-350, the layout is restored during restore operation 370. For example, the rotation introduced during rotate pad operation 340 is undone since it had no effect on the critical path.

FIG. 4 is a block diagram of a portion of a circuit layout including circuit elements (or circuit edges) 410 and 420 on either side of via 440 which is coupled to via pad 430. Via pad 430 is a rectangle having a longer dimension in the horizontal direction. Design rules require that elements be placed a certain distance apart. Thus, the via pad may be described as having a horizontal width W which is the horizontal length of via pad 430 plus the required space on each side of the via pad. In the illustrated embodiment, a critical path exists in the horizontal direction. Because pad 430 is rectangular, pad 430 may be rotated during operation 340 of FIG. 3. FIG. 5 shows via pad 530 which is a rotated version of via pad 430. Via pad 530 has been rotated 90° so that the longer dimension is in the vertical direction and the shorter dimension is now in the horizontal direction, thereby shortening the critical path in the horizontal direction.

FIG. 6 is an operational flow diagram illustrating an exemplary transistor finger resizing technique usable in the operational flow of FIG. 2. Generally, the size of critical path transistor fingers are reduced, and the reduced portions of the critical path transistor widths are redistributed to other fingers of that same logical transistor using free space in the circuit layout.

In general, length refers to channel length, and width refers to channel width. Those of skill in the art often refer to the physical lengths of fingers as “finger widths” measured in one (or more) direction(s) corresponding to the channel width of a transistor. Thus, the channel width is the sum of finger widths. Because the “length” dimension is often thought of as being greater in magnitude than the “width” dimension, and because finger widths are often longer than finger lengths (measured as with the channel), such language can be confusing. Thus, the total physical length of all of a transistor's fingers together (the channel-related finger widths added together) is equal to the channel width of the transistor. Of course, the channel width is defined in the orthogonal direction to the flow of current between the source and drain. Thus, portions of the channel width in the critical path may be reduced by resizing the finger widths. The widths of fingers in the critical path may be decreased and the widths of fingers outside the critical path may be increased while maintaining the overall channel width (total finger width) to maintain electrical equivalency, but while decreasing the physical dimension of the transistor present in the critical path. Because the fingers are oriented in the direction of the device/channel width, the longer dimension of the fingers is sometimes referred to as finger “width”. It should be apparent to one of skill in the art that in the present embodiment the channel length from source to drain is not affected, and the changes in “finger widths” and/or finger “physical lengths” refer to changes in the critical path direction which is generally orthogonal to the flow of current between the source and drain terminals.

During select finger operation 610, the next critical path finger of a transistor is selected for resizing. If there is no next critical path finger during decision 620, the resizing operational flow ends. A candidate for selection during select finger operation 610 is a finger which may extend outward from the physical objects which form a logical device such as a logical transistor, such extension outward being in the critical path. Therefore, reduction of the size of the extending finger will reduce the critical path, thereby reducing the area of the overall circuit layout.

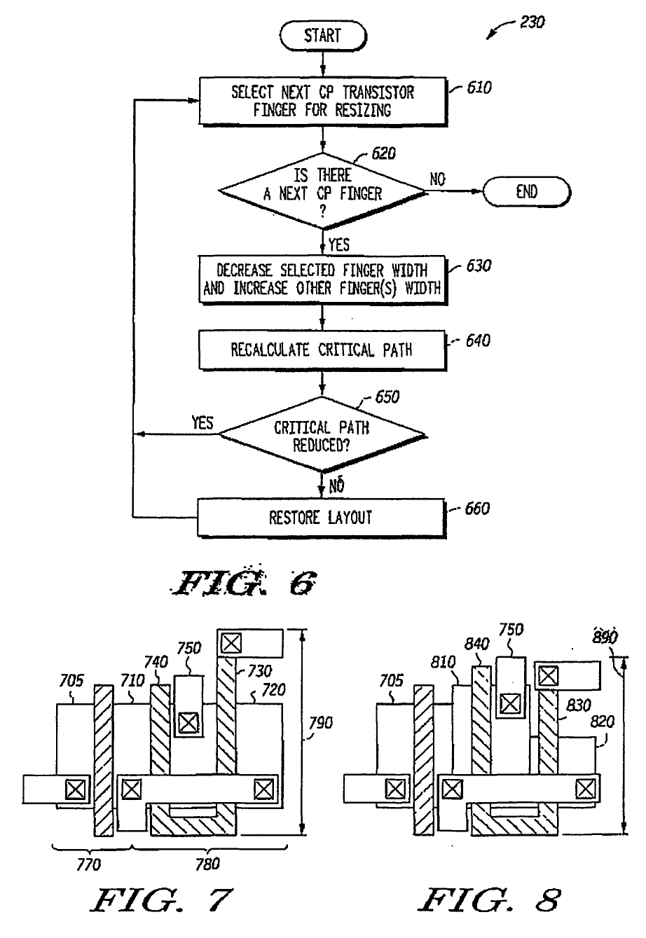

For example, referring to FIG. 7, a folded logical transistor 780 may include a source/drain diffusion area 710, 720 with a corresponding drain/source diffusion area disposed therebetween, and a gate disposed thereover, the gate including gate portions 730 and 740. (Also shown in FIG. 7 is a second, non-folded transistor 770 including a drain/source diffusion area 705 and a source/drain diffusion area 710 under a gate, wherein the diffusion area 710 provides the source/drain diffusion area of both logical transistors 770 and 780.) The gate portion extends from the main portion of transistor 780 at portion 730 causing an increased width 790 of the overall transistor chain structure of FIG. 7. As such, gate portion 730 is representative of a finger of transistor 780 which may be in a vertical critical path (as shown) and which therefore may be selected during finger selection operation 610 of FIG. 6.

During operation 630, the critical path width of the overall device is reduced by reducing the selected finger in the reference direction and increasing other fingers of the corresponding logical device which are not in the critical path. For example, after selecting critical path transistor finger 730 of transistor 780, the critical path width of device 780 is reduced by shortening finger 730 and lengthening finger 740. This effect is shown in FIG. 8 where shortened finger 730 corresponds to finger 830 and lengthened finger 840 corresponds to finger 840. The resizing performed during operation 630 results in an overall critical path reduction shown by device width 890 in FIG. 8 which is less than device width 790 in FIG. 7. If transistor 780 included other transistor fingers, such other transistor fingers could be increased as well as transistor finger 740. Other techniques may be described herein with reference to one transistor finger, but such techniques are generally useable for a group of transistor fingers.

After the finger resizing during operation 630, the critical path is recalculated during operation 640. If the critical path is determined to have been reduced during decision 650, a next critical path transistor finger is selected for resizing during select finger operation 610. If the critical path is determined to not have been reduced during decision 650, the layout is restored to a state prior to the finger resizing during operation 660, and a next critical path transistor finger is selected for resizing during select finger operation 610.

Resizing may result in an increase in finger width in the compaction direction, or may even result in an increase in width in a direction orthogonal to or at another angle to the compaction direction. This can be seen in FIGS. 7 and 8, where transistor finger width 740/840 actually increased in the compaction direction. Of course, transistor finger 740/840 did not increase in the critical path, and the overall critical path was shortened due to the decreased width of critical path transistor finger 730/830.

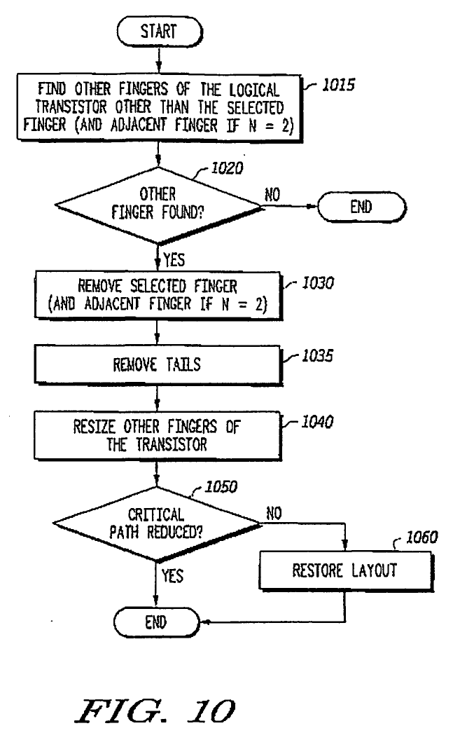

FIG. 9 is an operational flow diagram illustrating a technique for reducing a critical path by removal of object portions such as transistor fingers. If the compaction system determines during decision 910 that there is a critical path transistor finger which has not been selected, the next transistor finger in the critical path is selected for potential removal during operation 920. If the system determines during decision 930 that the selected transistor is on the transistor chain edge, it is removed during remove finger operation 940. In the case of operation 940, one transistor finger is to be removed, so a finger removal variable N is set to 1. The finger removal process is further discussed below with reference to FIGS. 10-14. After removal of the finger during operation 940, the system determines whether there is a next critical path transistor finger which has not yet been selected. If there is no next CP transistor finger, the finger removal flow ends. If there is a next CP transistor finger, control transitions to operation 920 for another iteration of the finger removal flow using the next selected transistor finger.

If during decision 930 the system determines that the transistor finger selected during operation 920 is not on the transistor chain edge, the system determines whether there is an adjacent finger during decision 950. If the system determines during decision 950 that there is no adjacent finger, the selected finger is removed during remove finger operation 980. In the case of operation 980, one transistor finger is to be removed, so the finger removal variable N is set to 1. The finger removal process is further discussed below with reference to FIGS. 10-14. After removal of the finger during operation 980, the system determines whether there is a next critical path transistor finger which has not yet been selected. If there is no next CP transistor finger, the finger removal flow ends. If there is a next CP transistor finger, control transitions to operation 920 for another iteration of the finger removal flow using the next selected transistor finger.

If the system determines during decision 950 that there is an adjacent finger in the transistor device, the selected transistor finger and an adjacent transistor finger are removed during remove fingers operation 960. In the case of operation 960, two transistor fingers are to be removed, so the finger removal variable N is set to 2. The finger removal process is further discussed below with reference to FIGS. 10-14. After removal of the fingers during operation 960, the system determines whether the critical path has been reduced during operation 970.

If the critical path has been reduced, the system determines if there is a next critical path transistor finger which has not yet been selected. If there is no next CP transistor finger, the finger removal flow ends. If there is a next CP transistor finger, control transitions to operation 920 for another iteration of the finger removal flow using the next selected transistor finger. If the critical path has not been reduced, then the layout is restored, and only the selected transistor is removed during operation 980.

FIG. 10 illustrates one embodiment useful for removing object portions such as transistor fingers. During find fingers operation 1015, other fingers of the transistor corresponding to the selected finger are found. If the selected finger and an adjacent finger are to be removed (N=2), then fingers other than the selected and adjacent fingers are identified. If the system does not find any other fingers of the transistor during decision 1020, the N fingers cannot be removed since there are no other fingers to absorb the loss of the removed fingers to maintain the functionality of the transistor. If the system finds other fingers during decision 1020, the N fingers (the selected finger if N=1, or the selected and adjacent fingers if N>1) are removed during operation 1030. After the N fingers are removed, any tails which previously connected the removed fingers to other fingers of the transistor are also removed during operation 1035. Once the N fingers and the corresponding tails have been removed, one or more of the remaining fingers are resized during resize operation 1040 to maintain the overall size of the transistor gate and drain regions thereby maintaining the functionality of the transistor. After the appropriate remaining fingers have been resized, the system determines if the critical path has been reduced. If the critical path has been reduced, the removal operation aided compaction. If the critical path was not reduced, the removal operation did not aid compaction of the overall circuit, and the circuit layout is restored at operation 1060.

FIGS. 11-14 further illustrate the device finger removal and resizing operations. FIG. 11 shows a transistor chain including transistors 1110, 1120 and 1130. As shown, transistor 1120 is a folded transistor in between transistors 1110 and 1130. Transistors 1110, 1120 and 1130 share some source/drain regions. Folded transistor 1120 includes a gate having a tail interconnect 1126 coupling fingers 1124 and 1122. If one of the fingers of transistor 1120 is in the critical path, it can be removed, and the remaining finger resized to compensate for such removal. If transistor 1120 had more than two fingers, and one or more of the fingers of transistor 1120 are in the critical path, one or more of the critical path finger(s) can be removed, and the remaining finger(s) resized to compensate for such removal.

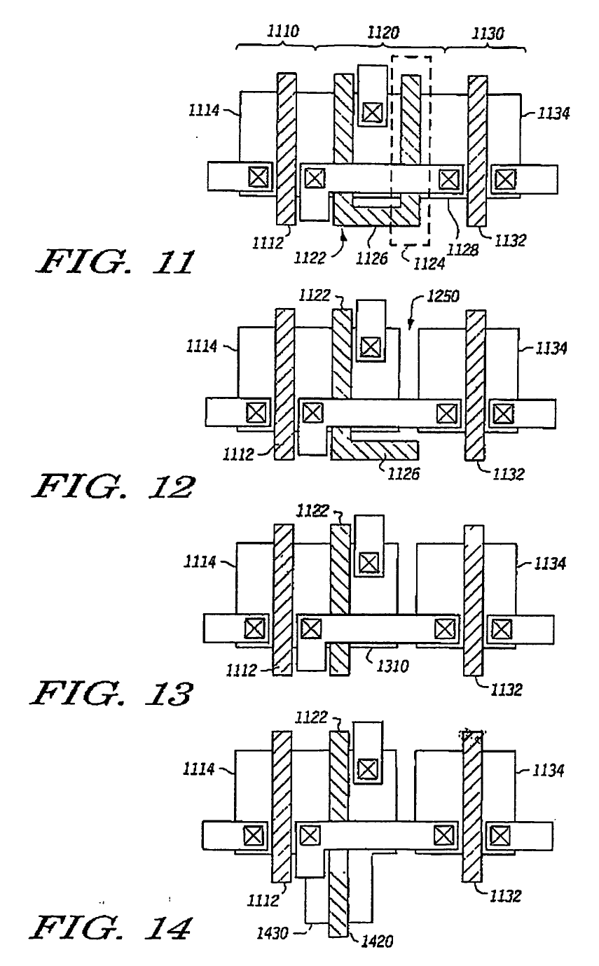

As shown in FIGS. 11 and 12, finger 1124 is determined to be in the critical path. Finger 1124 is selected and removed during remove finger operation 1030, and a diffusion gap 1250 is inserted as shown in FIG. 12. Tail 1126 is then also removed during remove tails operation 1035 leaving a space adjacent to source/drain region 1310 as shown in FIG. 13. After finger 1124 and tail 1126 are removed, finger 1122 is increased to compensate for the removal of finger 1124. As shown in FIG. 14, finger portion 1420 is added to finger 1122 so that the overall channel width of transistor 1120 remains substantially the same. Also as shown in FIG. 14, the source/drain regions are also resized to produce new source/drain portion 1430. In the illustrated embodiment, transistor 1120 is effectively unfolded.

Thus, critical path transistor fingers are removed. The width of the removed fingers is redistributed among other fingers of the corresponding transistor using free space found in an orthogonal direction. Tail removing is also performed, and rerouting is unnecessary. 2N adjacent transistors may be removed from any position in a physical transistor chain. 2N+1 transistor fingers may be removed from an end of a physical transistor chain. 2N+1 transistor fingers may be removed from any position in a physical transistor chain with diffusion gap insertion.

Group transistor fingers may also be removed. A transistor group is a set of adjacent transistors without contact between them and with contacts at the beginning and end of the group. A group of transistor fingers may be considered as one transistor finger and all above described operations for transistor fingers may be used for groups of transistor fingers. Two adjacent groups may be removed from any position of a transistor chain, or one group may be removed from inside a transistor chain with diffusion gap insertion.

The above description is intended to describe at least one embodiment of the invention. The above description is not intended to define the scope of the invention. Rather, the scope of the invention is defined in the claims below. Thus, other embodiments of the invention include other variations, modifications, additions, and/or improvements to the above description.

For example, although the examples are given in terms of transistors, other devices may benefit from the techniques taught herein. For example, capacitors may benefit from the techniques taught herein.

Those skilled in the art will recognize that circuit elements in circuit diagrams and boundaries between logic blocks are merely illustrative and to some extent perhaps even artificial, and that alternative embodiments may merge logic blocks or circuit elements or impose an alternate decomposition of functionality upon various logic blocks or circuit elements. Moreover, alternative embodiments may combine multiple instances of a particular component. For example, in the above described embodiment, a single latch 120 is shown, but various embodiments will often include multiple such latches or multi-bit latches.

Furthermore, those skilled in the art will recognize that boundaries between the functionality of the above described operations or stages merely illustrative. The functionality of various of the stages may be combined into a single operation, and/or the functionality of a single operations may be distributed in additional operations. Moreover, alternative embodiments may include multiple instances of a particular operation, and the order of operations may be altered in various other embodiments.

The foregoing components and devices are used herein as examples for sake of conceptual clarity. Consequently, as used herein the use of any specific exemplar herein is also intended to be representative of its class and the noninclusion of any specific devices in any exemplary lists herein should not be taken as indicating that limitation is desired.

The transistors described herein (whether bipolar, field effect, etc.) may be conceptualized as having a control terminal which controls the flow of current between a first current handling terminal and a second current handling terminal. An appropriate condition on the control terminal causes a current to flow from/to the first current handling terminal and to/from the second current handling terminal.

For example, in a bipolar NPN transistor, the first current handling terminal is the collector, the control terminal is the base, and the second current handling terminal is the emitter. A sufficient current into the base causes a collector-to-emitter current to flow. In a bipolar PNP transistor, the first current handling terminal is the emitter, the control terminal is the base, and the second current handling terminal is the collector. A current flowing between the base and emitter causes an emitter-to-collector current to flow.

Also, although field effect transistors (FETs) are frequently discussed as having a drain, a gate, and a source, in most such devices the drain is interchangeable with the source. This is because the layout and semiconductor processing of the transistor is frequently symmetrical. For an n-channel FET, the current handling terminal normally residing at the higher voltage is customarily called the drain. The current handling terminal normally residing at the lower voltage is customarily called the source. A sufficient voltage on the gate (relative to the source voltage) causes a current to therefore flow from the drain to the source. The source voltage referred to in n-channel FET device equations merely refers to which drain or source terminal has the lower voltage at any given point in time. For example, the “source” of the n-channel device of a bi-directional CMOS transfer gate depends on which side of the transfer gate is at the lower voltage. To reflect this symmetry of most n-channel FET devices, the control terminal may be deemed the gate, the first current handling terminal may be termed the “drain/source”, and the second current handling terminal may be termed the “source/drain”. Such a description is equally valid for a p-channel FET device, since the polarity between drain and source voltages, and the direction of current flow between drain and source, is not implied by such terminology. Alternatively, one current-handling terminal may arbitrarily deemed the “drain” and the other deemed the “source”, with an implicit understanding that the two are not distinct, but interchangeable.

Insulated gate FETs (IGFETs) are commonly referred to as MOSFET devices (which literally is an acronym for “Metal-Oxide-Semiconductor Field Effect Transistor”), even though the gate material may be polysilicon or some material other than metal, and the dielectric may be oxynitride, nitride, or some material other than an oxide. The use of such historical legacy terms as MOSFET should not be interpreted to literally specify a metal gate FET having an oxide dielectric unless the context indicates that such a restriction is intended.

Because the above detailed description is exemplary, when “one embodiment” is described, it is an exemplary embodiment. Accordingly, the use of the word “one” in this context is not intended to indicate that one and only one embodiment may have a described feature. Rather, many other embodiments may, and often do, have the described feature of the exemplary “one embodiment.” Thus, as used above, when the invention is described in the context of one embodiment, that one embodiment is one of many possible embodiments of the invention.

Notwithstanding the above caveat regarding the use of the words “one embodiment” in the detailed description, it will be understood by those within the art that if a specific number of an introduced claim element is intended in the below claims, such an intent will be explicitly recited in the claim, and in the absence of such recitation no such limitation is present or intended. For example, in the claims below, when a claim element is described as having “one” feature, it is intended that the element be limited to one and only one of the feature described. Furthermore, when a claim element is described in the claims below as including or comprising “a” feature, it is not intended that the element be limited to one and only one of the feature described. Rather, for example, the claim including “a” feature reads upon an apparatus or method including one or more of the feature in question. That is, because the apparatus or method in question includes a feature, the claim reads on the apparatus or method regardless of whether the apparatus or method includes another such similar feature. This use of the word “a” as a nonlimiting, introductory article to a feature of a claim is adopted herein by Applicants as being identical to the interpretation adopted by many courts in the past, notwithstanding any anomalous or precedential case law to the contrary that may be found. Similarly, when a claim element is described in the claims below as including or comprising an aforementioned feature (e.g., “the” feature), it is intended that the element not be limited to one and only one of the feature described merely by the incidental use of the definite article.

Furthermore, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

While particular embodiments of the present invention have been shown and described, it will be obvious to those skilled in the art that, based upon the teachings herein, various modifications, alternative constructions, and equivalents may be used without departing from the invention claimed herein. Consequently, the appended claims encompass within their scope all such changes, modifications, etc. as are within the true spirit and scope of the invention. Furthermore, it is to be understood that the invention is solely defined by the appended claims. The above description is not intended to present an exhaustive list of embodiments of the invention. Unless expressly stated otherwise, each example presented herein is a nonlimiting or nonexclusive example, whether or not the terms nonlimiting, nonexclusive or similar terms are contemporaneously expressed with each example. Although an attempt has been made to outline some exemplary embodiments and exemplary variations thereto, other embodiments and/or variations are within the scope of the invention as defined in the claims below.

What is claimed is:

1. A method of compacting a circuit layout comprising:
determining a critical path of a circuit layout;
performing an automated nonobject-increasing operation with respect to an object in the critical path for decreasing a size of the object in a direction of the critical path.

2. The method of claim 1 wherein the automated nonobject-increasing operation decreases the size of the object in the critical path by rotating the object.

3. The method of claim 1 wherein the automated nonobject-increasing operation decreases the size of an object in the critical path by reshaping the object.

4. The method of claim 1 wherein the automated nonobject-increasing operation decreases the size of an object in the critical path by redistributing at least a portion of the object.

5. The method of claim 1 wherein the performing the automated nonobject-increasing operation includes performing an object rotation operation on an object in the critical path.

6. The method of claim 5 wherein the object includes an interconnect pad.

7. The method of claim 5 wherein the object rotation operation includes:
rotating the object in the circuit layout.

8. The method of claim 7 wherein the object rotation operation further comprises:
determining whether the rotation of the object reduces the critical path.

9. The method of claim 7 wherein object has a width in a first dimension and a width in a second dimension orthogonal to the first dimension, wherein the width in the first dimension is greater than the width in the second dimension, wherein the rotating includes rotating the object such that the second direction is parallel with a compaction direction of the automated nonobject-increasing operation.

10. The method of claim 1 wherein the performing the automated nonobject-increasing operation includes performing an object redistribution operation on an object in the critical path.

11. The method of claim 10 wherein the performing the object redistribution operation includes performing a transistor width portion redistribution operation on a transistor width portion in the critical path.

12. The method of claim 11 wherein the performing the transistor width redistribution portion operation includes performing a transistor finger removing operation on a transistor finger in the critical path.

13. The method of claim 12 wherein the transistor finger is part of a logical transistor of the circuit layout, wherein the transistor finger removing operation includes redistributing the transistor finger to at least one other transistor finger of the logical transistor.

14. The method of claim 13 wherein the transistor finger is located in a middle portion of a transistor chain of the circuit layout, wherein transistor finger removing operation further comprises:
leaving a diffusion gap at a position in the transistor chain of the transistor finger being redistributed.

15. The method of claim 11 wherein the transistor width portion is part of a logical transistor of the circuit layout, the transistor width portion redistribution operation further comprises redistributing at least a portion of the transistor width portion to another transistor finger of the logical transistor.

16. The method of claim 15 wherein the transistor width portion redistribution operation further comprises:
determining whether the redistribution of the at least a portion of the transistor width portion reduces the critical path.

17. The method of claim 16 wherein the transistor width portion redistribution operation further includes restoring the at least a portion of the transistor width portion in the circuit layout if the redistribution is determined not to reduce the critical path in the determining.

18. A method of compacting a circuit layout comprising:
determining a critical path of a circuit layout;
performing an automated transistor width portion redistribution operation on a transistor width portion in the critical path for reducing the critical path.

19. The method of claim 18 wherein the transistor width portion is a transistor finger of a logical transistor of the circuit layout, the automated transistor redistribution operation further includes:
redistributing at least a portion of the transistor finger to at least one other transistor finger of the logical transistor.

20. The method of claim 19 wherein the redistributing further includes:
redistributing the transistor finger to at least one other transistor finger of the logical transistor.

21. The method of claim 20 wherein the transistor finger is located on the end of a transistor chain of the circuit layout.

22. The method of claim 20 wherein the transistor finger is located in a middle portion of a transistor chain of the circuit layout, wherein transistor finger redistribution operation further comprises:
leaving a diffusion gap at a position in the transistor chain of the transistor finger being redistributed.

23. The method of claim 20 wherein the transistor finger redistribution operation further includes redistributing a second transistor finger.

24. The method of claim 23 wherein the transistor finger and the second transistor finger are part of the same logical transistor of the circuit layout.

25. The method of claim 23 wherein the transistor finger is part of a first logical transistor and the second transistor finger is part of a second logical transistor.

26. The method of claim 19 wherein the redistributing at least a portion of the transistor finger to at least one other transistor finger further includes adding at least a portion of the at least a portion of the transistor finger to a transistor finger of the at least one transistor finger thereby increasing a width of the transistor finger of the at least one transistor finger, wherein the width of the transistor finger of the at least one transistor finger is in a direction generally parallel to a compaction direction of the automated transistor redistribution operation.

27. The method of claim 18 wherein the transistor width portion is part of a logical transistor, wherein the automated transistor redistribution operation further includes:
creating a new transistor finger;
moving at least a portion of the transistor width portion to the new transistor finger.

28. A method of compacting a circuit layout comprising:
determining a critical path of a circuit layout;
performing at least one of an object redistribution operation on an object in the critical path and an automated object rotation operation on an object in the critical path for compacting the circuit layout.

29. The method of claim 28 wherein the performing further includes performing an object rotation operation on an object in the critical path.

30. The method of claim 29 wherein the automated object rotation operation includes:
rotating the object in the circuit layout.

31. The method of claim 30 wherein the automated object rotation operation further comprises:
determining whether the rotation of the object reduces the critical path.

32. The method of claim 30 wherein the object includes an interconnect pad.

33. The method of claim 30 wherein object has a width in a first dimension and a width in a second dimension orthogonal to the first dimension, wherein the width in the first dimension is greater than the width in the second dimension, wherein the rotating includes rotating the object such that the second direction is parallel with a compaction direction of the automated nonobject-increasing operation.

34. The method of claim 28 wherein the operation is a nonobject increasing operation.

35. The method of claim 28 wherein:
the performing further includes performing an object redistribution operation on an object in the critical path;
the performing the object redistribution operation further includes performing a transistor width portion redistribution operation on a transistor width portion in the critical path.
